(19) United States
(12) Patent Application Publication
(10) Pub. No.: US 2022/0304496 A1
(43) Pub. Date: Sep. 29, 2022

(54) APPARATUS FOR COOKING FOODS IN LIQUIDS

(71) Applicant: Loco - Crazy Good Cookers, LLC, Milton, GA (US)

(72) Inventors: McDonald Plummer, Milton, GA (US); Blake Levien, Milton, GA (US)

(21) Appl. No.: 17/839,151

(22) Filed: Jun. 13, 2022

Related U.S. Application Data
(63) Continuation of application No. 16/797,897, filed on Feb. 21, 2020, now abandoned.
Application No. 16/797,897 is a continuation-in-part of application No. 16/050,192, filed on Jul. 31, 2018, now abandoned.
(60) Provisional application No. 62/808,826, filed on Feb. 21, 2019.
(60) Provisional application No. 62/549,307, filed on Aug. 23, 2017.
(60) Provisional application No. 62/538,877, filed on Jul. 31, 2017.

(51) Int. Cl. A47J 27/18; A47J 37/12; A47J 36/06; A47J 36/18; A47J 27/21

(52) U.S. Cl. CPC A47J 27/18; A47J 37/1219; A47J 36/06; A47J 36/18; A47J 27/21166; A47J 37/129; A47J 37/128

(57) ABSTRACT

A cooking apparatus for boiling or frying food. The cooking apparatus has an outer pot defining a cooking well containing the cooking liquid. A basket or inner pot is situated within the cooking well of the outer pot. The outer pot has two protrusions along its inner wall. The inner pot has two flanges along its outer wall. The inner pot may be rotated to align the flanges either with the protrusions of the outer pot or with the gaps between the protrusions. When aligned with the protrusions, the flanges rest on the protrusions, allowing the inner pot to drain.

### CROSS REFERENCE TO RELATED APPLICATIONS

This application is a continuation of U.S. patent application Ser. No. 16/797,897, filed Feb. 21, 2020, which claims the benefit of U.S. Provisional Application No. 62/808,826, filed on Feb. 21, 2019, and which is a continuation-in-part of U.S. patent application Ser. No. 16/050,192, filed Jul. 31, 2018, which claims benefit of U.S. Provisional Application No. 62/538,877 filed Jul. 31, 2017, and U.S. Provisional Application No. 62/549,307 filed Aug. 23, 2017. Each of these applications is incorporated by reference in its entirety herein.

### TECHNICAL FIELD

This disclosure relates generally to cooking devices, particularly to devices suitable for frying or boiling seafood, meats, or other foods.

### BACKGROUND

Cooking by means of boiling foods in water or another cooking liquid, or frying foods in oil, is well known. For commercial use or where there is a need to feed a large number of people (e.g., a backyard party or tailgate) boilers and fryers can be very large and may contain up to 90-180 quarts of liquid. Baskets or pots for containing the boiled or fried food may be similarly sized. What is needed is a cooking apparatus and method for draining the liquid from the cooked food that does not require handling the basket or pot while it drains.

### SUMMARY

In some respects the invention is directed to a cooking apparatus having an outer pot having two handles on an exterior surface of the outer pot and two inner protrusions on an interior surface of the outer pot, each inner protrusion secured to a handle; and an inner pot having a grip and two outer flanges, wherein each outer flange sized to fit within a gap between the two inner protrusions of the outer pot and further wherein the outer flanges and the inner protrusions have substantially the same diameter.

In other respects the invention is directed to a method for draining cooking liquid from an inner pot with cooked food within the inner pot, the inner pot having at least one perforation allowing cooking liquid to flow out of the inner pot and further having two flanges on the exterior of the inner pot, the inner pot being situated within an outer pot having two inner protrusions on the interior of the outer pot, the protrusions and the flanges having substantially the same diameter, the method having the steps of aligning the flanges of the inner pot with gaps between the protrusions of the outer pot; raising the inner pot until the flanges are above the protrusions; rotating the inner pot until the flanges are vertically aligned with the protrusions; and lowering the inner pot until the flanges rest on the protrusions.

### BRIEF DESCRIPTION OF THE DRAWINGS

FIG. 1 is a perspective view of a cooker according to one embodiment, with a rectangular cooking well.

FIG. 1A is a perspective view of a lid for a cooking apparatus, showing a window and door.

FIG. 2 is a perspective view of an outer pot for a pot-shaped cooking apparatus, showing handles on its exterior and protrusions on its interior at the same circumferential locations.

FIG. 2A is an exploded view of the outer pot of FIG. 2 showing the handles and protrusions.

FIG. 3 is a perspective view of a pot-shaped cooking apparatus with draining system for use with the outer pot of FIG. 2, according to one embodiment.

FIG. 4 is a view of the inner pot and outer pot of FIG. 3 nested together with the inner pot at its fullest extension into the outer pot, according to one embodiment.

FIG. 5 is a view of a lid for a cooking pot with draining system according to one embodiment.

FIG. 6 is a schematic showing two top-down views of the inner pot and outer pot when nested together, in two different states of alignment and non-alignment of their respective flanges and protrusions.

FIG. 7 is a perspective view of an alternative embodiment of the inner pot.

FIG. 8 is a perspective view of an embodiment of the inner pot, handle, and removable poultry rack.

FIG. 9 is a perspective view of the poultry rack.

### DETAILED DESCRIPTION

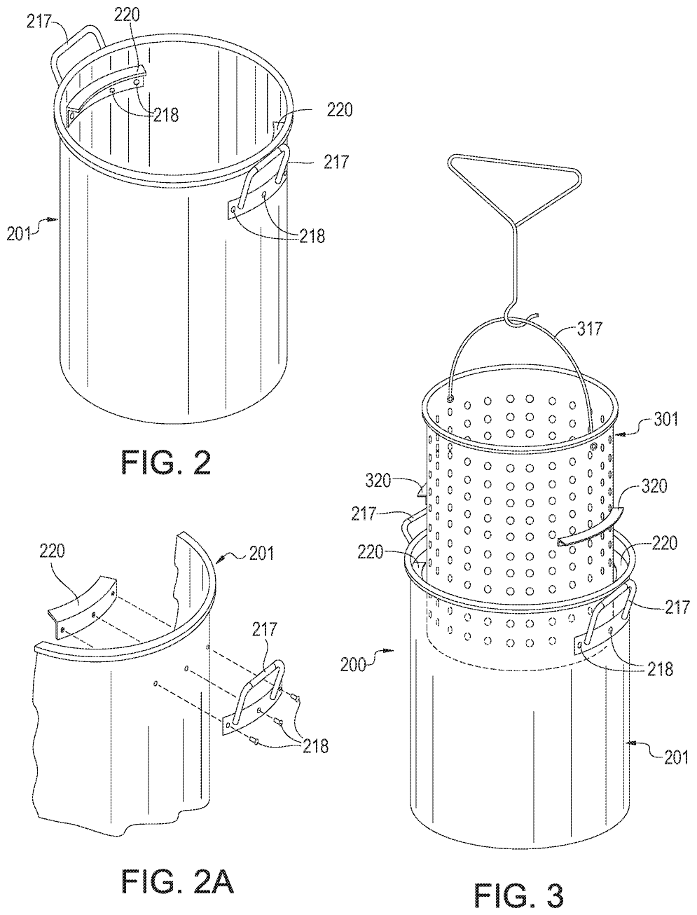

An apparatus 100 for cooking seafood, meats, or other foods in oil or water is disclosed. Generally, the apparatus includes a cooking well 101 to hold boiling liquids. The cooking well 101 is comprised of a bottom 103 and one or more substantially vertical side walls 102 to contain the cooking liquids, foods, and other structures facilitating the cooking. In some embodiments, the walls 102 comprise four side walls 102 forming a generally square or rectangular shape, and a bottom 103 floor In other embodiments, the cooking well 101 comprises a substantially cylindrical wall, such as is common for cooking pots. Such an embodiment is depicted in FIG. 2. The cooking well may be as large as 90-180 quarts.

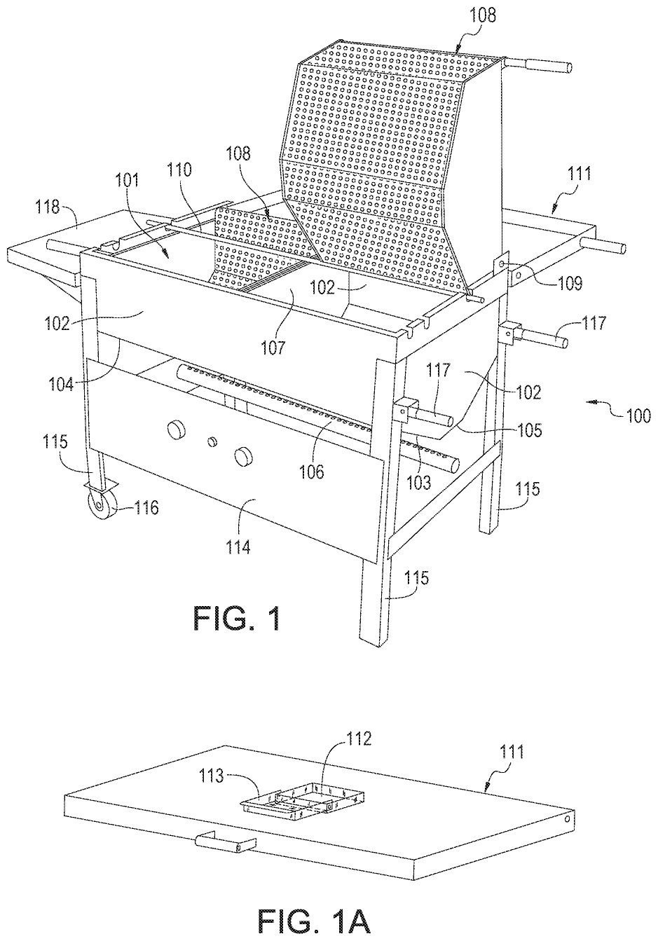

The bottom 103 floor of the cooking well 101 may be flat or it may be angled into a V shape, as is depicted in FIG. 1, or be set an angle with one end lower than the other. In some embodiments, the bottom 103 floor of the cooking well 101 is angled downward from the lower edge 104 of one or more of the vertical walls 102 to form an angled bottom 103. For example, in the embodiment comprising four side walls 102 in a generally rectangular shape, the bottom 103 may intersect at least one of the front and rear walls 102 in such a manner that when measured inside the cooking well 101, the angle between side wall 102 and bottom 103 is greater than 90°. It will be appreciated that when the bottom 103 intersects with both of two opposing walls 102 (e.g., the front and rear walls) at an angle to each, the two side surfaces of the bottom 103 will meet at a have a nadir 105 that is horizontally displaced inward of both such walls 102. The nadir 105 is the lowest point, line, or plane of the cooking well 101. In a basic configuration, the bottom 103 will have a “V” shape when viewed in cross-section, such as may be seen in FIG. 1, for example. Other cross-sectional shapes for the bottom 103 are also possible, such as a bend or curve, which in cross section would appear as a “U” or a crescent. In some embodiments, the nadir 105 itself may be a flat surface, such as a plane that is horizontally disposed, which in turn connects at an angle or curve to the inwardly- and downwardly-angled surfaces of the bottom 103.

Whatever the detail of the cross-sectional configuration, for embodiments in which the bottom 103 connects to the vertical sides by an angle or curve, the nadir 105 presents a portion of the cooking well 101 that is lower than the vertical walls 102 and angles upwards. When a flame, burner, or other heat source is placed beneath the nadir 105, the flame or heated air tends to flow upward along the upwardly angled surfaces of the bottom 103 by convection, while still hugging close to those surfaces. This may result in the heat being applied by the flame or air to a greater surface area of the cooking well 101 bottom 103 than might occur with a heating element 106, such as a gas burner 106, placed below a flat surface. Dependence on conduction within the material of the cooking well 101 itself for effecting heat distribution along the surface of the bottom 103 is thus reduced. In other words, compared to flat-bottomed containers, the use of the angled bottom 103 may allow convection to more uniformly heat a larger surface area of bottom 103 of the cooking well 101 more quickly, which in turn may reduce the time needed for the entire bottom 103 to be transferring optimum heat to the contents by conduction. Potential advantages of such a configuration may include more even heating of the contents of the cooking well 101 and reduction of the difference in temperature between the “hot spots” that are directly over burners 106 and other areas of the bottom 103. Such configurations may also as a consequence result in faster heating of the contents generally.

The nadir 105 may frequently be equidistant (horizontally speaking) from the vertical walls 102 to which the bottom 103 connects at an angle. However, it should be noted that the angle or curvature between the bottom 103 and one side wall 102 need not be the same as that for another side wall. Instead, different angles or curvatures can be used, which may have the effect of placing the nadir 105 in a location closer to one wall 102 or another. The nadir 105 may also be made closer to one wall 102 or another when the angle between one vertical wall 102 and another is the same, if the length of the bottom 103 surface between a first side wall 102 and the nadir 105 and is different from the length of the bottom surface 103 between a second side wall 102 and the nadir 105. Using these principles, the cooking well 101 can be configured relative to a heat source such that when the cooking well 101 is seated in place, the nadir 105 is positioned directly over a burner 106. If two or more burners 106 are near one another, the nadir 105 may be placed in such a way that the nadir 105 is near to, but between adjacent burners 106. This would allow flame or heated air from one burner 106 to rise up the surface of the bottom 103 to one side of the nadir 105, while the flame or heated air from another burner 106 may rise up the surface on the other side.

In some embodiments, the cooking well 101 is divided into two or more cooking chambers by a dividing wall 107 that extends from the upper edge of the well to the bottom 103 of the well. The dividing wall 107 is formed and attached to the bottom 103 floor of the apparatus such that the two or more cooking chambers are completely separated and may hold different cooking liquids. For example, one cooking chamber may hold oil, while another chamber holds boiling water. Alternatively, the separate chambers may hold the same liquid, but with different seasonings, or at different temperatures. Although FIG. 1 shows an example with two cooking chambers, it will be appreciated that the apparatus may include three or more chambers depending upon the size of the apparatus and the cooking needs.

The apparatus may also include one or more interior cooking baskets 108 sized and configured to be removably inserted into the cooking chamber. The bottom 103 surface of the cooking basket 108 may be flat or have other cross-sectional shapes. In cases where the cooking well 101 has an angled or curved bottom 103, some embodiments employ a bottom 103 surface of the cooking basket 108 that is angled from the front and rear edges of the basket 108 to form an angled bottom 103 with a shape that is complementary to the bottom 103 of the cooking well 101. The cooking baskets 108 may include a plurality of holes to allow the hot liquids to access the foods, and also be readily drained. In some embodiments, the cooking baskets 108 are connected to a wall, such as the rear wall, of the cooking chamber by a hinge 109 or other mechanism known in the art for allowing a rotatable connection. This may allow the baskets 108 to be rotated relative to the cooking chamber about a substantially horizontal axis, for purposes that may include draining the cooked foods, resting the cooked foods from the heat, dumping the cooked foods out for further processing or consumption.

In some embodiments, a rod 110 may be attachable across the space between two opposing sides walls 102 of the cooking apparatus such that rod 110 can extend across the area that the cooking basket 108 would occupy when in place. When the rod 110 is put in this position while the cooking basket 108 is removed, the rod 110 prevents the cooking basket 108 from being inserted, or from being fully inserted, into the cooking well 101. In some embodiments the rod 110 may be configured and positioned to support the cooking basket 108 above or near the cooking well 101. For example, a cook may occasionally desire to lift the cooking basket 108 above the water in the cooking well 101 to add seasoning, stir, take measurements, or adjust volume. Lifting the cooking basket, inserting the rod 110 in place, and then releasing the cooking basket 108 will cause the cooking basket 108 to be retained near the cooking well 101 in a hands-free position. The cook may now directly access the water and perform the steps desired, without having to either find a location to set down the cooking basket 108 and its contents, or to attempt to hold the cooking basket 108 while performing other tasks. In accordance with some embodiments employing this feature, the cooking baskets 108 may be retained in the upright position show in FIG. 1 by means of a support rod 110 that passes from one edge of the cooking chamber to the other, below the upright basket. In some embodiments, the support rod 110 rests in a pair of notches located in each the upper side walls 102 of the cooking apparatus. In some embodiments there are multiple pairs of notches in the upper side walls 102 to allow the placement of the support rod 110 in alternative positions.

Through such placement of the rod 110, the basket 108 may be supported in varying degrees of rotation relative to the cooking well 101 and the rod 110 may also serve to prevent the unwanted removal of the baskets 108 from the cooking well 101, by passing above the cooking basket 108 when it is in its fully lowered position. For example, FIG. 1 shows the rod 110 restraining rotation of the left basket, while supporting the right basket 108 in an upright position. The cooking baskets 108 may include a handle, which may be coated with a heat-resistant coating to protect the hands of a user. The cooking baskets 108 may be independently operated to allow the contents of one basket 108 to be drained, while the contents of the other basket 108 continue to cook as shown in FIG. 1.

The apparatus may include a lid 111, an embodiment of which is further depicted in FIG. 1A. The lid 111 may be attached to the rear wall 102 of the cooking well 101 by a hinge or other rotatable mechanism known in the art, and may include a handle, which may be coated with a heat-resistant coating to protect the hands of the user. In some embodiments, the lid 111 further comprises a window 112 therethrough which may have a door 113. In such embodiments, the door 113 may be opened during cooking to allow seasonings or other items to be inserted into the one or more cooking wells 101 without need to open the lid 111 of the apparatus. The door 113 may be hinged such that it swings open on top of the lid 111. In other embodiments, the door 111 may slide over or away from the window 112. If desired, the door 113 may have sides that operate as a chute or funnel when lifted. The sides may be in a fixed orientation relative to the door 113, such that they extend downwardly and into the window 112 when the door 113 is closed. It will be appreciated that once opened these fixed sides rotate relative to the apparatus lid 111, but in fixed relation to the door 113. In some embodiments, the door 113 is on the top of the lid 111. The door 113 may be constructed and configured to present its inner surface as a horizontal flat surface when opened. Materials like seasonings or additional food components can be placed on the door 113 when opened, following which closing of the door 113 will also naturally deposit the seasonings and components into the apparatus. If desired, the door 113 can be configured such that the surface is large enough and of an appropriate inner material that the door 113 itself can be used as a small table for minor preparation tasks like chopping an onion or slicing a pepper. When the preparation task is complete, closing the door 113 automatically deposits the items in the cooking apparatus without the need to clean a separate cutting board or table.

Returning to FIG. 1, the apparatus may be mounted on a cooking stand 114. The stand 114 may include adjustable heating elements 106. In some embodiments the heating elements may be gas burners. In other embodiments, the heating elements may be electric. The heating elements may be controlled by analog or digital controllers as generally known in the art. The stand 114 may also include legs 115 for stability. In some embodiments, the stand 114 may comprise four stationary legs 115, such that the apparatus remains in one position. In other embodiments, the stand 114 may comprise a pair of stationary legs 115, and a pair of legs 115 with wheels 116. The wheels 116 may be fixed to the side of the leg 115 or may be free to swivel in the form of casters. In such embodiments, the apparatus may be movable from one location to another. In embodiments where the apparatus is mobile, it may further comprise a handle or handles 117 to facilitate movement, such that the apparatus may be tipped up onto its wheel while the user holds the handles 117 to adjust the position. In some embodiments, the stand 114 comprises a table portion 118. The table portion 118 may be attached by a hinged mechanism that allows the table to be in an extended position parallel to the surface of the ground during use (as depicted in FIG. 1), and in a collapsed position perpendicular to the surface of the ground when not in use, or when the apparatus is being transported from one location to another. The stand 114 may further comprise one or more hooks or arms for the convenient storage of cooking tools (FIG. 3).

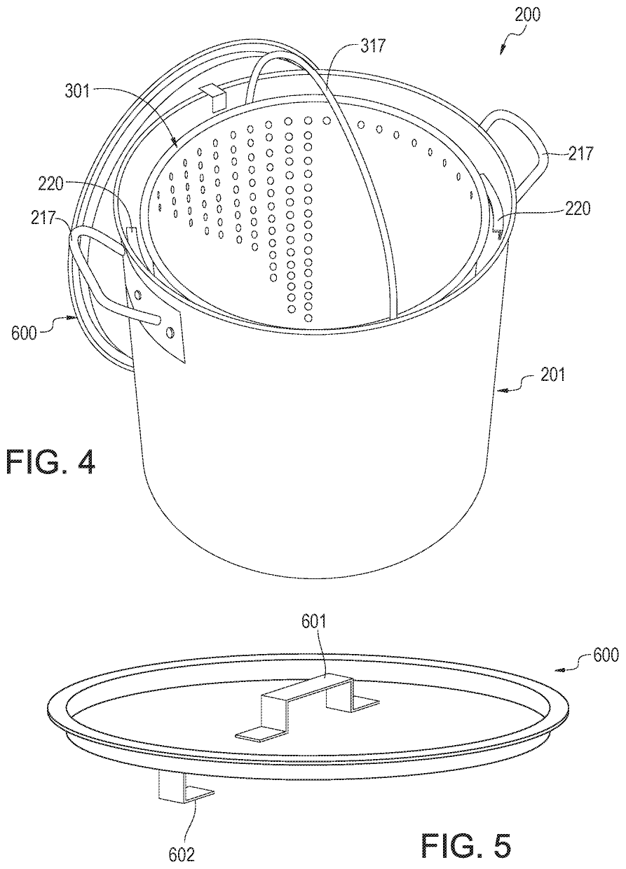

As shown in FIGS. 2-5, another embodiment of the invention may be described as a generally pot-shaped cooking apparatus 200. It may have a generally pot-shaped cooking well with a pot-like strainer. In an embodiment, the cooking well comprises an outer pot 201 with a pair of handles 217 on opposite sides of the exterior surface. The handles 217 may be integrally formed with the outer pot 201 or attached by any attachment mechanism 218 known in the art, including for example bolts, rivets, or welds. The handles 217 may be coated with a heat-resistant material to protect the hands of the user. The interior of the outer pot 201 may include a pair of protrusions 220 arranged on opposite sides of the interior wall and extending into the cooking chamber. The protrusions 220 may be manufactured as a separate structure from the outer pot 201, such as L-brackets, posts, flanges 320, or other structures that can be affixed to the inside of the outer pot 201. In some embodiments, the protrusions 220 are attached by structures extending through the vertical wall of the outer pot 201, such as by rivets, bolts, screws or the like, but it is also possible to weld or otherwise secure protrusions 220 in place without extending structures through the vertical wall. Alternately, the protrusions 220 can be formed into the outer pot 201 itself. For example, the protrusions 220 may be roll-formed or cast into the outer pot 201 as an area of decreased diameter.

The protrusions 220 are preferably located in the upper half of the height of the outer pot 201. In some embodiments, the protrusions 220 are located in the upper one quarter of the pot. Protrusions 220 are preferably spaced approximately equal distances from one another about the inner circumference of the outer pot 201. As discussed below with respect to the inner pot 301, these protrusions 220 should be wide enough and strong enough to allow flanges 320 of the inner pot 301 to rest on them in some configurations, and yet spaced apart enough to allow those flanges 320 to pass between them. The circumferentially measured gap between the protrusions 220 thus needs to be at least slightly longer than the flange 320 of the inner pot 301 that is to be used. The protrusions 220 should each extend less than one quarter of the circumference of the inner wall of the outer pot 201, such that the total circumferential length of the protrusions 220 is less than one half of the circumference of the outer pot 201. In some embodiments, the outer pot 201 contains two protrusions 220 spaced substantially equidistant from one another. The two protrusions 220 may have a circumferential length approximately one-sixth (⅙) of the circumference of the outer pot 201, which would leave a gap of about one-third (⅓) of the circumferential length between them. Alternatively, the two protrusions 220 may have a circumferential length approximately one-eighth (⅛) of the circumference of the outer pot 201, which would leave a gap of about three-eighths (⅜) of the circumferential length between them.

In some embodiments, the protrusions 220 form part of the handle 217 structure of the pot, which may also provide increased strength. Securing the protrusions 220 in this manner also may have manufacturing and other benefits such as, for example, fewer holes and fasteners being required since the handle 217 and protrusion 220 may share the same holes and fastening structures. Coordinating the handles 217 and protrusions 220 in the same location also facilitates the user knowing where the protrusions 220 are when the outer pot 201 is in use, which otherwise might be difficult or inconvenient when the pot is filled with material, closed, or steaming.

In one such embodiment, the protrusions 220 are secured to the inner wall by the bolts, rivets, or other fasteners that secure the handles 217 to the exterior. In other embodiments, part of the handle 217 material may extend into the interior of the pot to form the protrusion 220, or to form an attachment point for the protrusion 220. For example, the ends of the two sides of the handle 217 may be threaded at the end and configured passthrough holes in the side wall of the pot, while the protrusion 220 may have holes that align with both the holes in the side wall and the threaded posts. Nuts can be secured to the threading after assembly of the protrusion 220 onto the threaded pots, thus securing both the protrusion 220 and the handle 217 to the pot. Alternately, part of the protrusion 220 may extend from the exterior of the pot to the outside in similar manner. In some embodiments either the handle 217 material or the protrusion 220 material, or both, may extend through the pot, or it may extend over the upper lip of the pot and be secured by fasteners or welding. Also alternately, the handles may be attached by a screw and nut, bolt, or other fastener to a strap or bar applied to the outside of the bot, with the protrusion secured by the fastener to the interior wall opposite the strap or bar, as depicted in FIG. 2A.

The draining system further includes an inner pot 301. The inner pot 301 is sized and configured to fit within the interior of the outer pot 201. The inner pot may include one or more handles. The grips 317 may comprise a pair of grips 317 arranged on opposite sides of the inner pot 301 or may comprise a looped handle that is attached at two points on opposite sides of the pot, and which may rotate to fold down into an upper lip of the pot when not in use and rotate into a vertical position when the pot is carried. Other known structures for handling a pot may also be used. The interior pot may include a plurality of drain holes extending through the walls of the pot. The drain holes may be arranged in any pattern and may be along the side walls and bottom 103 surface of the pot. If desired, the inner pot 301 may be a wire or mesh basket or other structure in which the holes occupy greater surface area than the material.

The inner pot 301 further comprises at least two flanges 320 extending outward from the exterior of the sidewalls of the pot. Flanges 320 may be L-brackets, posts, flanges 320, or other structures that can be affixed to the inside of the outer pot 201. The flanges 320 may be similar in appearance and structure to the protrusions 220 on the inside of the outer pot 201. In some embodiments, flanges 320 are located near the midpoint of the inner pot 301, such that they are located between the upper and lower quarter of the height of the pot.

The overall diameter of the inner pot 301, when measured to include the flanges 320, is referred to as 1P-OD (inner pot, outer diameter) 501. The IP-OD 501 should be less than the inner diameter of the vertical walls of the outer pot 201, but greater than the diameter between the protrusions 220 in the outer pot 201. (This diameter between the protrusions within the outer pot 201 is referred to as the OP-ID (outer pot, inner diameter) 504 for convenience.) This will leave an annular flange-to-pot gap 505 between the flanges 320 and the outer pot 201. The diameter of the inner pot 301 when measured without the flanges 320 (which is the IP-ID (inner pot-inner diameter) 502 IP-ID 502 will naturally be smaller still than its overall diameter with the flanges 320 1P-OD 501, and should be less than the diameter between the protrusions 220 in the outer pot 201 OP-ID 504. This will leave an annular pot-to-protrusion gap 506 between the inner pot 301 and the protrusions 220, and a greater annular inner pot-to-outer pot gap 507. Such an arrangement should allow the inner pot 301 to be inserted within the outer pot 201, with the main body of the inner pot 301 able to pass below the protrusions 220 of the outer pot 201. However, when the protrusions 220 and flanges 320 are aligned with each other, the flanges 320 cannot pass by the protrusions 220. In some embodiments, the overall diameter of the inner pot 301 including flanges 320 is approximately 90-99% of the diameter of the outer pot 201 IP-OD 501. The protrusions 220 of the outer pot 201 and the flanges 320 of the inner pot 301 may be sized and configured such that they extend approximately the same distance. In some embodiments, the amount of extension of the protrusions 220 and flanges 320 from the side walls of the outer and inner pot 301, respectively, may be between 0.5 cm and 5 cm. Neither the flange 320 nor the protrusion 220 should be wider than the annular inner pot-to-outer pot gap 507.

Flanges 320 are preferably spaced approximately equal distances from one another about the circumference of the inner pot 301. The circumferential length of the flanges 320 will depend on the number of flanges 320 to be used. The number, length, and placement of flanges 320 may also be selected with reference to the expected number, length, and placement of protrusions 220 in the outer pot 201 with which the inner pot 301 is expected to be used.

In some embodiments, a pair of flanges 320 is used. For an inner pot 301 having at least two flanges 320, each flange 320 should extend less than one quarter of the circumference of the outer wall of the inner pot 301. In some embodiments, for an inner pot 301 with two flanges 320, the flanges 320 have a circumferential length of approximately 12%-20% of the circumference of the inner pot 301. In a preferred embodiment, the flanges 320 have a circumferential length of approximately 15%-17% of the circumference of the inner pot 301. In order to allow the inner pot 301 to nest fully within the outer pot 201, the circumferential length of the flanges 320 should be smaller than the gap between the protrusions 220 inside the outer pot 201. While increasing the circumferential length may increase strength of the flanges 320 in some embodiments, the tradeoff is that a longer circumferential length of the flange 320 requires greater precision when the user attempts to pass the flanges 320 between the protrusions 220 of the outer pot 201. For pots of large size, such as 24-quart sizes used for crawfish boils and the like, such precision is typically difficult owing to the weight of the contents. It is therefore desirable in some embodiments to provide for flanges 320 that are not approximately equal to the circumferential gap between the protrusions 220. In terms of percentages, for purposes of scaling to different sized pots, some embodiments will have flanges 320 that are no more than 40%-70% of the gap between protrusions 220 of the outer pot 201. In some preferred embodiments, the gap between the flanges 320 is approximately twice the circumferential length of the flanges 320. For example, applying this relationship, an inner pot 301 with two flanges 320 might have each flange 320 occupy approximately ⅙ of the circumference of the inner pot 301, with each flange 320 equidistant from the other and separated by approximately one-third of the inner pot 301 circumference.

As discussed more fully below, in operation, when the user wishes to drain cooking liquid, the inner pot 301 is raised and twisted to align the flanges 320 with the protrusions 220. It therefore may be desirable for the inner pot 301 to have an indication that is readily visible to the user regarding the location of the flanges 320. This indication may be a visual marker, such as printing, stamping or etching, or it may be a structure that aligns with the flanges 320. In some embodiments, the handle attachment for the inner pot 301 is manufactured to align vertically with the flanges 320. Thus, when the user picks up the inner pot 301 using the grips 317, the user immediately and intuitively may know where the flanges 320 are. Similarly, it may be desirable for the outer pot 201 to have an indication readily visible to the user regarding the location of the protrusions 220. Like for the inner pot 301, the indication may be a visual marker such as printing, stamping or etching, or it may be a structure that aligns with the flanges 320. For embodiments in which the handles 217 of the outer pot 201 are located immediately outward of the protrusions 220, the handles 217 of the outer pot 201 serve as this indication. This is the case whether the handles 217 share the same mounting hardware, form part of the protrusion 220, or are just located in the same circumferential position.

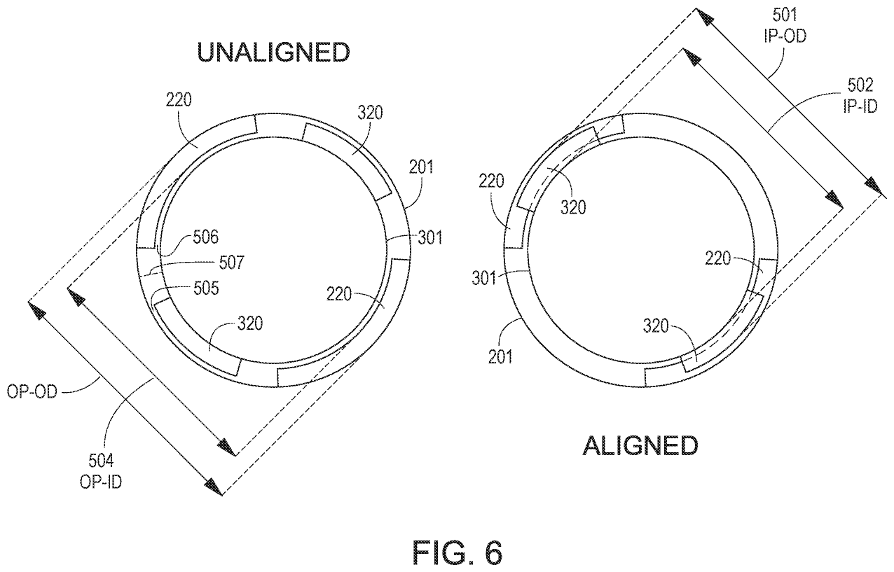

The protrusions 220 of the outer pot 201 and inner pot 301 are sized and configured such that when they are arrange in opposite orientations, they allow the inner pot 301 to be completely within the outer pot 201 during cooking but may be aligned to contact each other to provide support for the inner pot 301 and drain the liquids from therein back into the outer pot 201 when they are aligned in the same orientation, as shown in FIG. 6. When the inner pot 301 is to be inserted into the outer pot 201 for cooking, the inner pot 301 is rotated until the flanges 320 are completely unaligned with the protrusions 220 of the outer pot 201. The inner pot 301 may then be lowered completely into the outer pot 201, with the inner flanges 320 passing the protrusions 220 without interaction, as shown in FIG. 6. When cooking is completed and the user desires to drain the contents, the flanges 320 of the inner pot 301 and protrusions 220 of the outer pot 201 must be aligned such that the inner pot 301 is lifted out without the flanges 320 striking the protrusions 220 as the inner pot 301 is lifted, as shown in FIG. 6. Once the flanges 320 have cleared the height of the protrusions 220, the inner pot 301 is rotated until the flanges 320 and protrusions 220 are aligned. The inner pot 301 may then be lowered until the flanges 320 rest upon the protrusions 220 and support the inner pot 301 in the raised position, allowing the liquids to drain, as shown in FIG. 6. In this way, the hot liquids may be safely drained back into the outer cooking pot, and the protrusions 220 and flanges 320 interact to support the weight of the pot such that the user need not hold the inner pot 301 while it drains and risk injury.

In such a way, placement may be coordinated with the location of the protrusions 220 in the outer pot 201 to allow for partial or complete draining of the liquid in the outer pot 201 from the contents being cooked in the inner pot 301. For example, for an inner pot 301 and outer pot 201 having approximately the same depth, if the flanges 320 are approximately halfway up the side of the inner pot 301, and the protrusions 220 are at the top of the outer pot 201, resting the flanges 320 on the protrusions 220 will cause the bottom 103 of the inner pot 301 to be raised approximately halfway up the outer pot 201. Depending on the amount of liquid being used for cooking, this may raise the inner pot 301 and its contents partially or wholly out of the liquid, while still allowing both pots to remain together for conducting cooking tasks like stirring, seasoning, inspection, or removal, or for other purposes such as movement or storage.

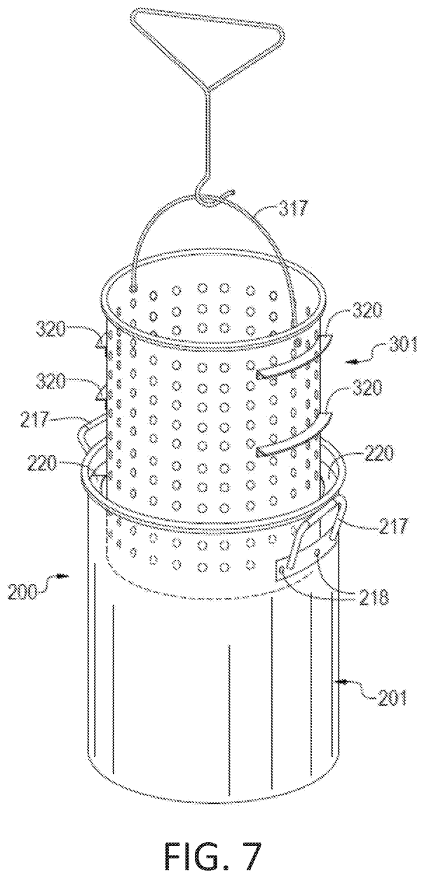

In other embodiments, such as that shown in FIG. 7, multiple sets of flanges 320 may be provided, each set at different vertical levels about the outside of the inner pot 301. This provides a user multiple locations for setting the inner pot. For example, a set of flanges 320 near the top of the inner pot 301 would provide for the inner pot to be only partially raised, which may allow for steaming rather than boiling the food inside the pot while keeping the lid closed. Another set of flanges 320 may be provided approximately halfway down the side of inner pot 301, which would allow the pot to be removed completely from the cooking liquid. FIG. 7 depicts an embodiment of an inner pot 301 with two sets of flanges 320 provided at multiple levels along the outside of the inner pot 301.

When indicators are present on the inner pot 301 or the outer pot 201, the user's task in aligning the protrusions 220 and flanges 320 is eased, as the user need only look to the location of the indication to know his or her target. When both inner pot 301 and outer pot 201 have indicators, the task is easier still, as the user simply aligns the indicators to know that the flange 320 and protrusions 220 are aligned. In some embodiments, the grips 317 of the inner pot 301 serve as an indicator for the location of the flanges 320, and the handles 217 of the outer pot 201 serve as an indicator of the location of the protrusions 220. The user simply aligns the grips 317 and the handles 217 to align the flanges 320 and protrusions 220. In operation, to fully insert the inner pot 301 into the outer pot 201 to the deepest insertion point, the user locates the grips 317 of the inner pot 301, locates the handles 217 of the outer pot 201, inserts the inner pot 301 within the outer pot 201 with their respective grips and handles out of alignment. To partially remove insert the inner pot 301 from the outer pot 201, the user simply locates the handle of the inner pot 301, lifts the inner pot 301 to the point that the flanges 320 pass the protrusions 220, twists the inner pot 301 until the grip(s) 317 of the inner pot 301 align with the handles 217 of the outer pot 201, and sets the inner pot 301 with its flanges 320 resting on the protrusions 220.

The cooking system may also comprise a pot lid 600, as shown in FIG. 5. The pot lid 600 may include a lid grip 601 which may be integrally formed with the pot lid 600 or may be attached by any means known in the art, including rivets, bolts, or welding. In some embodiments, the pot lid 600 may further comprise a hook or arm 602 on the inner surface. The hook 602 is sized such that it may be slideably attached to the size wall of the pot to store the pot lid 600 while it is removed from the cooking pot, such as by placing the hook 602 over the top edge of the open pot. This may be done on the outer pot 201, or on the inner pot 301 when it is lifted to drain the contents. In certain embodiments, the hook 602 is closer to the edge of the pot lid 600 than to the center. In some embodiments, the hook 602 may be closer to the center of the pot lid 600, but as the hook 602 gets nearer and nearer to the center, so does the propensity of the pot lid 600 to be in the way of the user when hung on the hook 602. In some embodiments, the hook opening is substantially larger than the width of the outer pot 201 wall material at the top. Particularly for large-sized items, moving the pot lid 600 while being affected steam and other distractions of cooking can be cumbersome, and thus a large hook opening allows for easier seating of the hook 602. Preferably, the hook opening is at least three times the width of the outer pot 201 wall material at the top.

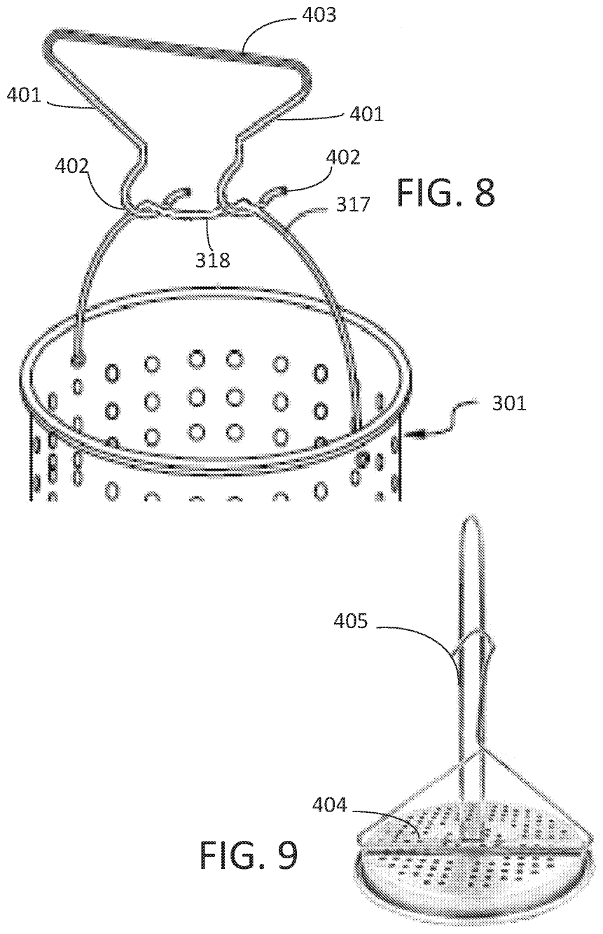

In some embodiments the cooking system may further include a removable handle such as that depicted in FIG. 8. The removable handle has at least one body 401 extending to one or more hooks 402 for latching onto the inner pot grip 317 or other equipment in the cooking system. In the embodiment shown in FIG. 7, the removable handle has one hook, and in the embodiment shown in FIG. 8, the removable handle has two hooks 402. Similarly, the inner pot grip 317 may include corresponding peak(s). In FIG. 8, the inner pot grip has two peaks that are spaced from a center 318 by the same distance apart as the hooks 402 of the removable handle. This allows the removable handle to lift the inner pot 301 by the inner pot grip 317 using two points of contact, which increases stability. The removable handle may include a body 403 extending between first and second body 401. The first and second body 401 may each extend distally from the body 403 in an inward direction to the hook(s) 402. The removable handle shown in FIG. 8 also has an insulated coating to prevent burning the user's fingers while in use. This insulated coating may also be applied to the inner pot grip or to other surfaces that a user may be likely to touch or grab in the course of cooking.

Other equipment may also be used in connection with the inner pot 301 to lower food into the pot or raise it out of the pot. For example, as depicted in FIG. 9, a poultry rack 404 may be used to secure a prepared chicken carcass or other large cut or body of meat. The poultry rack 404 may then be lowered into the pot for cooking. When the chicken is cooked, the poultry rack 404 may be removed by means of the central elongated handle 405 on the rack. The user may also use a removable handle to lift the poultry rack 404.

What is claimed is:

1. A method for cooking comprising:
receiving an inner pot within an interior of an outer pot, the outer pot having a first protrusion and a second protrusion each extending inwardly from an interior surface, the second protrusion disposed radially opposite the first protrusion, the inner pot including a first flange and a second flange each disposed on an outer surface of the inner pot, the second flange disposed radially opposite the first flange, the inner pot including at least one hole extending between the outer surface and an inner surface of the inner pot;
receiving the inner pot in a first position within the interior of the outer pot following a first rotation of the inner pot from an aligned state to an unaligned state and a lowering of the inner pot distally into the interior of the outer pot towards a bottom of the outer pot, the aligned state including the first flange vertically aligned with the first protrusion and the second flange vertically aligned with the second protrusion, the unaligned state including the first flange vertically unaligned with the first protrusion and the second flange vertically unaligned with the second protrusion, the lowering of the inner pot distally into the interior of the pot including the first flange and the second flange moving past the first protrusion and the second protrusion without interaction until the inner pot is in the first position;
cooking contents held in the inner pot using a cooking liquid while the inner pot is disposed in the first position; and
receiving the inner pot in a second position within the interior of the outer pot following a raising of the inner pot proximally towards a top of the outer pot and a second rotation of the inner pot from the unaligned state to the aligned state, the second position including the first flange resting on the first protrusion and the second flange resting on the second protrusion, the second position at least partially draining the cooking liquid from the inner pot into the outer pot.

2. The method of claim 1, wherein an inner grip is attached to the inner pot at a first point and a second point, the first point being positioned relative to the first flange and the second point being positioned relative to the second flange.

3. The method of claim 2, wherein the inner grip includes at least one peak.

4. The method of claim 3, wherein the inner grip pivots between a folded position and a vertical position, the vertical position including the at least one peak disposed over a top of the inner pot.

5. The method of claim 4, further comprising:
engaging at least one hook of a removable handle to the at least one peak of the inner grip of the inner pot, at least one of the first rotation, the lowering, the second rotation, or the raising of the inner pot caused by the removable handle.

6. The method of claim 5, wherein the first point being positioned relative to the first flange and the second point being positioned relative to the second flange provides a first visual indication in connection with the at least one of the first rotation, the lowering, the second rotation, or the raising of the inner pot.

7. The method of claim 6, wherein the first protrusion is positioned relative to a first handle disposed on an exterior surface of the outer pot and the second protrusion is positioned relative to a second handle disposed on the exterior surface of the outer pot, the first protrusion being positioned relative to the first handle and the second protrusion being positioned relative to the second handle providing a second visual indication in connection with the at least one of the first rotation, the lowering, the second rotation, or the raising of the inner pot, the first visual indication and the second visual indication corresponding to positioning of the first flange and the second flange relative to the first protrusion and the second protrusion.

8. The method of claim 1, further comprising:
receiving a lid grip of a pot lid on a top edge of the outer pot.

9. The method of claim 1, wherein a third position is disposed between the first position and the second position, the first position corresponding to the first flange and the second flange each being positioned below the first protrusion and the second protrusion, the second position corresponding to the first flange resting on the first protrusion and the second flange resting on the second protrusion, the third position corresponding to a third flange resting on the first protrusion and a fourth flange resting on the second protrusion, the third flange and the fourth flange positioned between the first flange and the second flange and a bottom of the inner pot.

10. The method of claim 9, wherein the first position corresponds to boiling the contents in the cooking liquid, the second position corresponds to at least partially draining the cooking liquid, and the third position corresponds to steaming the contents using the cooking liquid.

11. A cooking apparatus comprising:
an outer pot having an exterior surface opposite an interior surface;
a first protrusion extending from the interior surface of the outer pot;
a second protrusion extending from the interior surface of the outer pot, the second protrusion disposed radially opposite the first protrusion;
an inner pot having an inner surface opposite an outer surface, the inner pot including at least one hole extending between the inner surface and the outer surface;
a first flange extending from the outer surface of the inner pot; and
a second flange extending from the outer surface of the inner pot, the second flange disposed radially opposite the first flange, the inner pot configured to rotate between an aligned state and an unaligned state within the outer pot and translate vertically between a first position and a second position within the outer pot, the aligned state including the first flange vertically aligned with the first protrusion and the second flange vertically aligned with the second protrusion, the unaligned state including the first flange vertically unaligned with the first protrusion and the second flange vertically unaligned with the second protrusion, the first position including the first flange and the second flange disposed below the first protrusion and the second protrusion, the second position including the first flange resting on the first protrusion and the second flange resting on the second protrusion, the first position corresponding to a cooking of contents in a cooking liquid and the second position corresponding to at least a partial draining of the cooking liquid.

12. The cooking apparatus of claim 11, wherein an inner grip is attached to the inner pot at a first point and a second point, the first point being positioned relative to the first flange and the second point being positioned relative to the second flange.

13. The cooking apparatus of claim 12, wherein the inner grip includes at least one peak.

14. The cooking apparatus of claim 13, wherein the inner grip is configured to pivot between a folded position and a vertical position, the vertical position including the at least one peak disposed over a top of the inner pot.

15. The cooking apparatus of claim 14, further comprising:
at least one hook of a removable handle, the at least one hook removably engageable to the at least one peak of the inner grip of the inner pot, the inner pot being configured to rotate and translate using the removable handle.

16. The cooking apparatus of claim 15, wherein the first point being positioned relative to the first flange and the second point being positioned relative to the second flange provides a first visual indication in connection with rotation and translation using the removable handle.

17. The cooking apparatus of claim 16, wherein the first protrusion is positioned relative to a first handle disposed on an exterior surface of the outer pot and the second protrusion is positioned relative to a second handle disposed on the exterior surface of the outer pot, the first protrusion being positioned relative to the first handle and the second protrusion being positioned relative to the second handle providing a second visual indication in connection with the rotation and translation using the removable handle, or the raising of the inner pot, the first visual indication and the second visual indication corresponding to positioning of the first flange and the second flange relative to the first protrusion and the second protrusion.

18. The cooking apparatus of claim 11, further comprising:
a lid grip of a pot lid configured to be received on a top edge of the outer pot.

19. The cooking apparatus of claim 11, wherein a third position is disposed between the first position and the second position, the first position corresponding to the first flange and the second flange each being positioned below the first protrusion and the second protrusion, the second position corresponding to the first flange resting on the first protrusion and the second flange resting on the second protrusion, the third position corresponding to a third flange resting on the first protrusion and a fourth flange resting on the second protrusion, the third flange and the fourth flange positioned between the first flange and the second flange and a bottom of the inner pot.

20. The cooking apparatus of claim 19, wherein the first position corresponds to boiling the contents in the cooking liquid, the second position corresponds to at least partially draining the cooking liquid, and the third position corresponds to steaming the contents using the cooking liquid.
